(19) United States
(12) Patent Application Publication
(10) Pub. No.: US 2026/0030498 A1
(43) Pub. Date: Jan. 29, 2026

(54) METHOD FOR IMPROVING MEMORY AND ELECTRONIC DEVICE PERFORMING THE SAME

(71) Applicant: Hyojin LEE, Bucheon-si Gyeonggi-do (KR)

(72) Inventor: Hyojin LEE, Bucheon-si Gyeonggi-do (KR)

(21) Appl. No.: 19/273,264

(22) Filed: Jul. 18, 2025

(30) Foreign Application Priority Data
Jul. 23, 2024 (KR) 10-2024-0096824

(51) Int. Cl. G06N 3/08

(52) U.S. Cl. CPC G06N 3/08

(57) ABSTRACT

Provided is a method for improving memory including: obtaining a first identifier; obtaining a second identifier; determining whether the second identifier corresponds to the first identifier; displaying first content corresponding to the first identifier or the second identifier if the second identifier corresponds to the first identifier; and correcting the second identifier if the second identifier does not correspond to the first identifier.

### CROSS-REFERENCE TO RELATED APPLICATIONS

This application claims priority to and the benefit thereof under 35 U.S.C. § 119 to Korean Patent Application No. 10-2024-0096824 filed in the Korean Intellectual Property Office on Jul. 23, 2024, the entire contents of which are incorporated herein by reference.

### BACKGROUND

### (a) Field

The present disclosure relates to a method for improving memory and an electronic device performing the same.

### (b) Description of the Related Art

Various methods for improving memory ability have been studied, and a memory game is an example of such methods, having an effect of enhancing attention and visual memory. A traditional memory game is a game in the form of card flipping, which proceeds by matching the same pictures.

Recently, with the development of digital technology, research is being conducted to implement a memory game through various platforms such as computers, smartphones, and tablets. However, digital memory games have been pointed out to have a limitation in that they provide lower game immersion compared to conventional analog memory games and cannot provide social interaction and sensory experiences. In particular, since social interaction and sensory experiences are important factors in the developmental process of infants and children, a memory game targeting infants and children is being demanded.

### SUMMARY

Some embodiments are to provide a method for improving memory and an electronic device performing the same using a memory game while providing social interaction and sensory experiences.

However, the problems to be solved by the present disclosure are not limited to those mentioned above, and may include problems that are not mentioned but can be clearly understood by those skilled in the art from the following description.

The problems to be solved by the present disclosure are not limited to those mentioned above and may be extended to various matters derived from embodiments described below.

The present disclosure may provide a method for improving memory, including: obtaining a first identifier; obtaining a second identifier; determining whether the second identifier corresponds to the first identifier; displaying first content corresponding to the first identifier or the second identifier if the second identifier corresponds to the first identifier; and correcting the second identifier if the second identifier does not correspond to the first identifier.

In some embodiments, the method may further includes: invalidating the first identifier and the second identifier if the second identifier corresponds to the first identifier; obtaining a third identifier; obtaining a fourth identifier; determining whether the fourth identifier corresponds to the third identifier; displaying second content corresponding to the third identifier or the fourth identifier if the fourth identifier corresponds to the third identifier; and correcting the fourth identifier if the fourth identifier does not correspond to the third identifier.

In some embodiments, the method may further includes: invalidating the first identifier and the second identifier if the second identifier corresponds to the first identifier; determining a number of invalidated identifiers; determining a first score if the number of invalidated identifiers reaches a predetermined number; and obtaining a third identifier if the number of invalidated identifiers does not reach the predetermined number.

In some embodiments, wherein the determining the first score comprises: determining the first score based on at least one of a first play time, a first error rate, and a first number of attempts; obtaining a score improvement method by inputting the first score to an artificial neural network if the first score is greater than a reference value; and maintaining the first score if the first score is less than or equal to the reference value.

In some embodiments, wherein the determining the first score comprises: determining the first score as a sum of the first play time, the first error rate, and the first number of attempts.

In some embodiments, the method may further includes: restarting a memory game after executing the score improvement method if the first score is greater than the reference value; determining a second score based on at least one of a second play time, a second error rate, and a second number of attempts of the restarted memory game; and training the artificial neural network based on the first score, the second score, and the reference value.

In some embodiments, wherein the training the artificial neural network comprises: determining a first reward as a reward for the artificial neural network if the second score is higher than the first score; determining a second reward as the reward if the second score is lower than the first score but higher than the reference value; and determining a third reward as the reward if the second score is lower than the reference value, wherein the first reward is less than zero, the second reward is greater than or equal to zero, and the third reward is greater than the second reward.

In some embodiments, wherein the training the artificial neural network comprises: training the artificial neural network based on a cumulative number of plays, the first score, the second score, and the reference value.

In some embodiments, the method may further includes: detecting, using a camera, a memory game apparatus on which the first identifier and the second identifier are arranged; determining whether the entire memory game apparatus is recognized; obtaining the first identifier if the entire memory game apparatus is recognized; and displaying an instruction to detect the entire memory game apparatus if the entire memory game apparatus is not recognized.

The present disclosure may provide an electronic device for improving memory, including: at least one processor; and a memory connected to the at least one processor, wherein the memory is configured to store a program, wherein the at least one processor is configured to execute the program, and wherein, if executed, the program causes the at least one processor to perform the steps of the method according to an embodiment.

### BRIEF DESCRIPTION OF THE DRAWINGS

The above and other aspects, features, and advantages of certain embodiments of the present disclosure will become apparent from the following description taken in conjunction with the accompanying drawings, in which:

FIG. 1 is a schematic block diagram of an electronic system according to an embodiment.

FIG. 2 is a diagram for illustrating a memory game apparatus according to an embodiment.

FIG. 3 is a diagram for illustrating a memory game apparatus according to an embodiment.

FIG. 4 is a diagram for illustrating an interaction between a memory game apparatus and an electronic device according to an embodiment.

FIG. 5 is a flowchart of a method for improving memory according to an embodiment.

FIG. 6 is a flowchart of a method for improving memory according to an embodiment.

FIG. 7 is a flowchart of a method for improving memory according to an embodiment.

FIG. 8 is a flowchart of a method for improving memory according to an embodiment.

FIG. 9 is a diagram for illustrating a training session of an artificial neural network according to an embodiment.

FIG. 10 is a diagram for illustrating a structure of an artificial neural network according to an embodiment.

FIG. 11 is a diagram for illustrating a training session of an artificial neural network according to an embodiment.

### DETAILED DESCRIPTION OF THE INVENTION

In the following detailed description, only certain embodiments of the present invention have been shown and described, simply by way of illustration. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the disclosure. The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

As used herein, the singular forms “a” and “an” are intended to include the plural forms as well, unless the context clearly indicates otherwise. Although the terms first, second, and the like may be used herein to describe various elements, components, steps and/or operations, these terms are only used to distinguish one element, component, step or operation from another element, component, step, or operation.

As used herein, each of such phrases as “A or B,” “at least one of A and B,” “at least one of A or B,” “A, B, or C,” “at least one of A, B, and C,” and “at least one of A, B, or C,” may include any possible combination of the items enumerated together in a corresponding one of the phrases.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment,” “in an embodiment,” “in an example embodiment,” and similar language throughout this disclosure may, but do not necessarily, all refer to the same embodiment.

Hereinafter, various embodiments of the present disclosure are described with reference to the accompanying drawings.

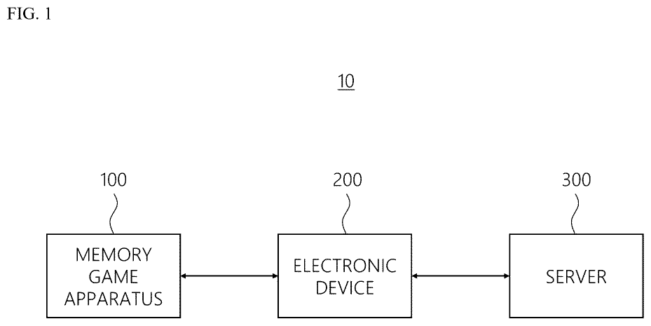

FIG. 1 is a schematic block diagram of an electronic system according to an embodiment. Referring to FIG. 1, an electronic system 10 according to an embodiment includes a memory game apparatus 100, an electronic device 200, and a server 300. The electronic system 10 may provide a memory game for improving memory ability of a user. In some embodiments, the electronic system 10 is used to improve memory in infants and children, and an instructor who guides the learning of such infants and children may configure the electronic system 10 to provide social interaction and sensory experiences. For example, the instructor may pre-fill contents (or items) of the memory game apparatus 100 and store content associated with the contents in the electronic device 200. Infants and children may proceed with the memory game using the memory game apparatus 100 and the electronic device 200 set by the instructor.

The memory game apparatus 100 may include a plurality of detachable storage units. Each storage unit may include a compartment that stores contents, a cover part that hides the contents from the outside, and a button part that fastens the cover part to the compartment. In some embodiments, the plurality of storage units may be implemented in a hexagonal shape. A user may press a button to separate the cover part from the compartment. The cover part may be fixed to one side of the compartment and be configured to rotate. The cover part may be marked with an identifier on a bottom surface, and as the cover part is separated from the compartment and rotated, the identifier on the bottom surface may be exposed externally.

In some embodiments, the plurality of storage units may include a plurality of pairs having the same identifier. For example, among the plurality of storage units, a first storage unit and a second storage unit may include a first identifier on the bottom surface of the cover part, and a third storage unit and a fourth storage unit may include a second identifier on the bottom surface of the cover part. Here, the first storage unit and the second storage unit may be one pair, and the third storage unit and the fourth storage unit may be another pair. In some embodiments, the number of the plurality of storage units may be implemented in various even-numbered configurations. The instructor may fill the storage units having the same identifier with the same contents. The instructor may detach and rearrange the plurality of storage units.

The electronic device 200 is configured to provide Augmented Reality (AR) or Mixed Reality (MR), and may include at least one processor, a memory (for example, volatile memory and/or non-volatile memory), a camera, and a display. In some embodiments, the electronic device 200 may be configured to provide Virtual Reality (VR). For example, the electronic device 200 may be implemented as a personal computer (PC), a laptop computer, a mobile phone, a smart phone, a tablet PC, or a wearable device. Examples of the wearable device may include smart glasses, a Head Mounted Display (HMD), and the like.

The at least one processor of the electronic device 200 may be configured to implement steps of the method for improving memory by executing a program stored in the memory. The memory may be connected to the at least one processor and may be configured to store the program.

The camera may capture the memory game apparatus 100 in real time. When a cover part of the memory game apparatus 100 is opened by a user, the camera may capture an identifier on the bottom surface of the cover part. The camera may transmit the captured image (or video frame) to the at least one processor. The camera may be an image sensor.

The at least one processor may display a second image on the display based on a first image captured by the camera. For example, the at least one processor may generate the second image by performing image processing on the first image. The image processing may include visual effects (e.g., animation effects), auditory effects (e.g., sound), and tactile effects (e.g., vibration), and the like.

In some embodiments, the at least one processor may determine whether the memory game apparatus 100 is entirely recognized (or detected or identified). For example, on each corner of a top surface of the memory game apparatus 100 on which the plurality of storage units are arranged, a mark for recognition by the electronic device 200 may be arranged. The mark for recognition may be implemented by printing or engraving an identifier or a mark, or by forming a structure, and the implementation thereof is not particularly limited. The at least one processor may determine that the memory game apparatus 100 is entirely recognized when four marks at the corners of the memory game apparatus 100 are recognized in the image received through the camera. The at least one processor may determine that the memory game apparatus 100 is not entirely recognized when at least one of the four marks at the corners of the memory game apparatus 100 is not recognized in the image received through the camera. The at least one processor may provide an instruction through the display to adjust a position of the camera when the memory game apparatus 100 is not entirely recognized.

In some embodiments, the at least one processor may determine whether identifiers of the opened cover parts correspond to each other. As an example, a user may open the cover parts of a first storage unit and a second storage unit. The at least one processor may recognize first identifiers of the first storage unit and the second storage unit from an image received through the camera, and may determine that the identifiers correspond to each other. The at least one processor may display content corresponding to the identifiers on the display if the identifiers correspond to each other. After displaying the content, the at least one processor may invalidate the first identifiers. For example, the at least one processor may mark the first identifiers as matched and exclude them from future recognition. That is, even if the first identifier is recognized in the image received through the camera, the at least one processor may ignore it.

As another example, the user may open the cover parts of a first storage unit and a third storage unit. The at least one processor may recognize the first identifier of the first storage unit and a second identifier of the third storage unit from the image received through the camera, and may determine that the identifiers do not correspond to each other. If the identifiers do not correspond to each other, the at least one processor may instruct the user through the display to open a different storage unit. The at least one processor may instruct the user to open a storage unit other than the first storage unit and/or the third storage unit through the display.

In some embodiments, the at least one processor may determine whether the memory game has been completed. The at least one processor may determine whether the memory game has been completed based on whether the number of invalidated identifiers reaches a predetermined number. The at least one processor may determine that the memory game has been completed when the number of invalidated identifiers reaches the predetermined number. The predetermined number may correspond to the total number of storage units in the memory game apparatus 100. The at least one processor may determine that the memory game has not been completed when the number of invalidated identifiers does not reach the predetermined number.

The at least one processor may determine a first score based on a game result when the memory game is completed. In some embodiments, a lower score may indicate a relatively better performance (e.g., fewer errors or faster completion), and a higher score may indicate a relatively inferior performance. The at least one processor may determine whether the first score is greater than a reference value. If the first score is greater than the reference value, the at least one processor may transmit the first score to the server 300.

The server 300 may generate a score improvement method based on the first score and may transmit the score improvement method to the electronic device 200. The score improvement method may indicate a set of instructions or guidance intended to help the user achieve a better score in the memory game. The server 300 may be implemented as a data center, an Artificial Intelligence (AI) device, or the like. The server 300 may include an artificial neural network. The artificial neural network may be implemented as a module that provides a Large Language Model (LLM). The artificial neural network may include parameters (or weights or biases) trained to generate an optimal score improvement method for the given score when the score is input. The server 300 may implement the artificial neural network by including AI accelerators such as a Graphics Processing Unit (GPU) or a Neural Processing Unit (NPU) for parallel computation, and a High Bandwidth Memory (HBM).

After executing the score improvement method, the electronic device 200 may allow the user to replay the memory game (or play the memory game again). The electronic device 200 may determine a second score of the replayed memory game. The electronic device 200 may transmit the second score to the server 300.

The server 300 may train the artificial neural network based on the second score. In some embodiments, the server 300 may train the artificial neural network using a reward generated based on the first score, the second score, and the reference value. For example, the server 300 may update the weights of the artificial neural network based on the first score, the second score, and the reference value. In another embodiment, the server 300 may train the artificial neural network using a reward generated based on the number of plays, the first score, the second score, and the reference value. In some embodiments, the reward may be generated by the electronic device 200 or the server 300. That is, the reward may be computed locally or remotely depending on the implementation.

In some embodiments, the electronic device 200 may be implemented to include an artificial neural network. The artificial neural network may support on-device AI by running a Small Language Model (SLM) or a lightweight variant of a Large Language Model (sLLM). In this case, the electronic system 10 may include the memory game apparatus 100 and the electronic device 200.

As such, the electronic system 10 according to an embodiment may support a memory game through the interaction between the memory game apparatus 100 and the electronic device 200, and may enhance (or support) a user's social interaction and sensory experiences by recommending an optimal method for improving a game score from the server 300 according to the result of the memory game.

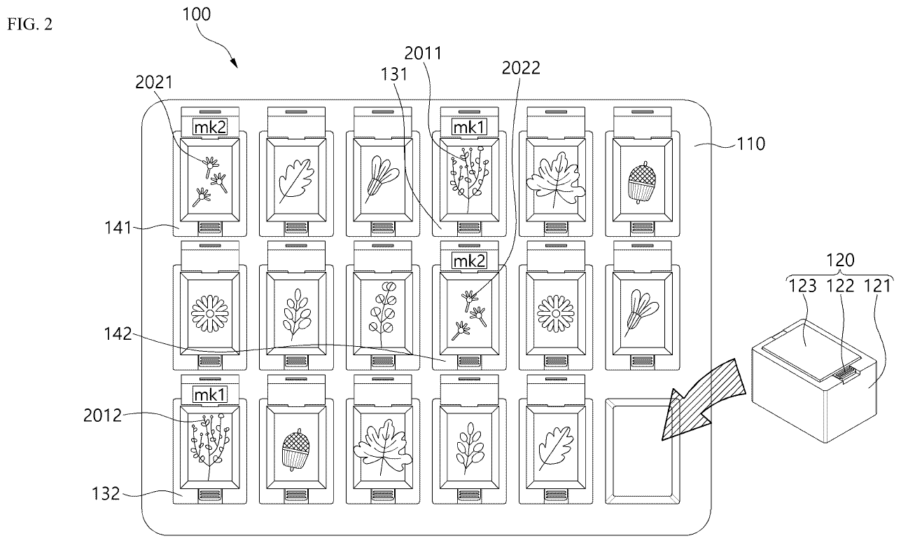

FIG. 2 is a diagram for illustrating a memory game apparatus according to an embodiment. Referring to FIG. 2, a memory game apparatus 100 according to an embodiment may include a base board 110 and storage units 120. The base board 110 may include a plurality of holes for placing the storage units 120. The storage units 120 may be implemented as a plurality of detachable units and may be attached to and detached from the plurality of holes of the base board 110. An instructor may configure a new game by adjusting the placement of the storage units 120 on the base board 110 when composing a memory game.

The storage unit 120 according to an embodiment may include a compartment 121 for storing contents, a cover part 123 for hiding the contents from the outside, and a button part 122 for fastening the cover part 123 to the compartment 121.

The memory game apparatus 100 according to an embodiment may include a first pair composed of a first storage unit 131 and a second storage unit 132, and a second pair composed of a third storage unit 141 and a fourth storage unit 142. The first pair, including the first storage unit 131 and the second storage unit 132, may include a first identifier mk1 on the bottom surface of the cover part, and the second pair, including the third storage unit 141 and the fourth storage unit 142, may include a second identifier mk2 on the bottom surface of the cover part. In some embodiments, the identifiers mk1 and mk2 may be marked by a marking device. In some embodiments, the identifiers mk1 and mk2 may be marked in the form of a barcode, an Aztec code, a QR code, a microcode, or the like, and the marking method is not particularly limited.

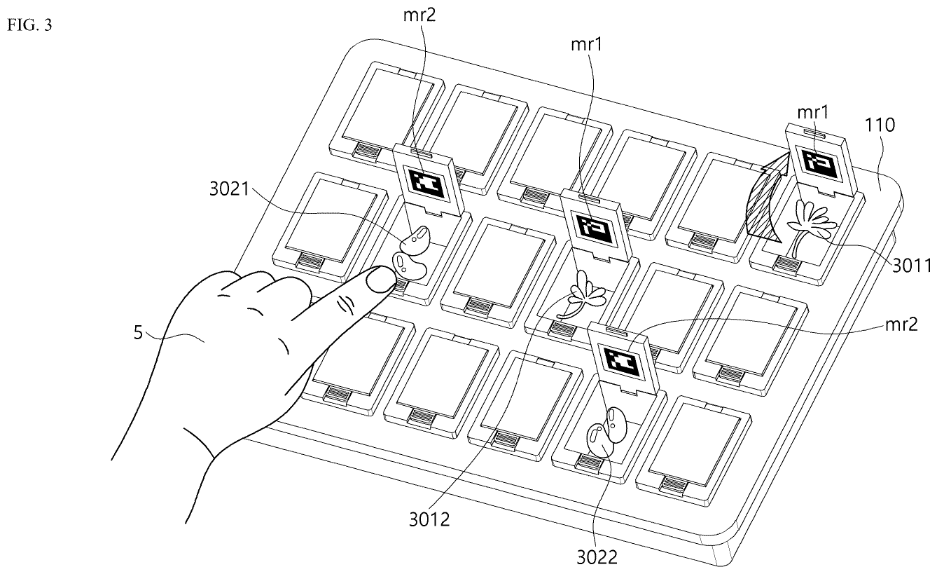

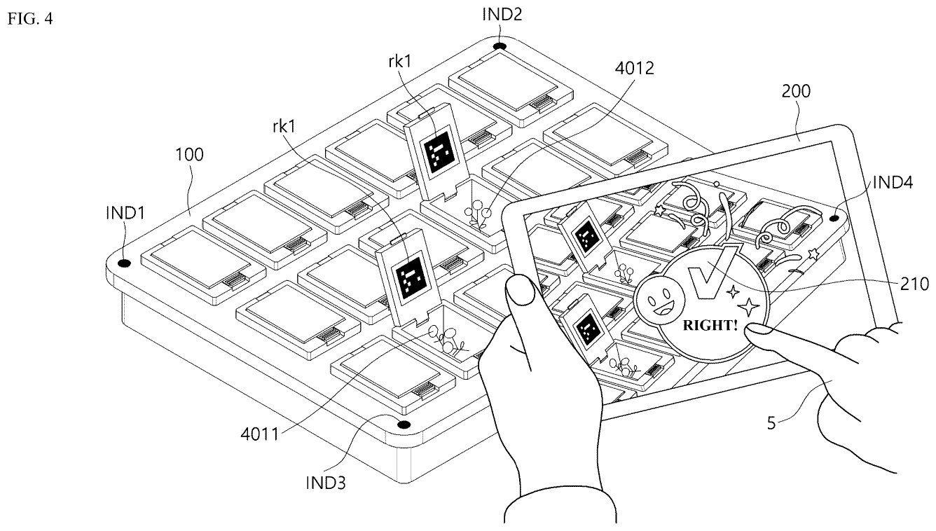

An instructor may place first pieces of contents (or items) 2011 and 2012 into the first storage unit 131 and the second storage unit 132 of the first pair, and may place second pieces of contents (or items) 2021 and 2022 into the third storage unit 141 and the fourth storage unit 142 of the second pair. A user (for example, an infant or a child) may play the memory game configured by the instructor. A configuration in which the user plays the memory game apparatus 100 will be described later with reference to FIGS. 3 and 4.

In FIG. 2, for convenience of explanation, the first to fourth storage units 131, 132, 141, and 142 are described. However, the memory game apparatus 100 may further include storage units not illustrated with reference numerals in the figure.

FIG. 3 is a diagram for illustrating a memory game apparatus according to an embodiment. Referring to FIG. 3, a user 5 may play the memory game using the memory game apparatus. The user 5 may open the cover parts of the storage units arranged on the base board 110. The user 5 may open the first storage unit to check content 3011, and may open the second storage unit to check content 3012. First identifiers mr1 may be marked on the bottom surfaces of the cover parts of the first and second storage units. An electronic device (for example, the electronic device 200 of FIG. 1) may confirm that the first identifiers mr1 of the first storage unit and the second storage unit correspond to each other (i.e., determine that the first identifiers mr1 match), and may display content corresponding to the first identifiers mr1. The instructor of the user may store in advance, in the electronic device, the content corresponding to the first identifiers mr1. For example, the content corresponding to the first identifiers mr1 may be related to the pieces of contents 3011 and 3012.

In addition, the user 5 may open the third storage unit to check content 3021, and may open the fourth storage unit to check content 3022. Second identifiers mr2 may be marked on the bottom surfaces of the cover parts of the third and fourth storage units. The electronic device may confirm that the second identifiers mr2 of the third storage unit and the fourth storage unit correspond to each other, and may display content corresponding to the second identifiers mr2. The instructor may store in advance, in the electronic device, the content corresponding to the second identifiers mr2. For example, the content corresponding to the second identifiers mr2 may be related to the pieces of contents 3021 and 3022.

FIG. 4 is a diagram for illustrating an interaction between a memory game apparatus and an electronic device according to an embodiment. Referring to FIG. 4, the electronic device 200 according to an embodiment may capture the memory game apparatus 100 using a camera. The electronic device 200 may determine whether the entire memory game apparatus 100 is recognized. Indicators IND1 to IND4 for recognition may be arranged at respective corners of a top surface of the memory game apparatus 100. The indicators IND1 to IND4 may be implemented by printing or engraving an identifier or a mark, or by forming a structure, and the implementation thereof is not particularly limited.

The electronic device 200 may determine that the memory game apparatus 100 is not entirely recognized if at least one of the four indicators IND1 to IND4 at the corners of the memory game apparatus 100 is not recognized in an image received through the camera. If the entire memory game apparatus 100 is not recognized, the electronic device 200 may provide an instruction to adjust the camera position (or angle) through the display.

The electronic device 200 may determine that the entire memory game apparatus 100 is recognized if the four indicators IND1 to IND4 at the corners of the memory game apparatus 100 are recognized in the image received through the camera. In some embodiments, the plurality of storage units of the memory game apparatus 100 may include a visual indicator on an upper surface of each cover part indicating that it is closed. The visual indicator may be referred to as a closed-state mark. The closed-state marks of the cover parts may be all identical. When the memory game starts, the electronic device 200 may determine whether a predetermined number of closed-state marks are recognized. The predetermined number may be equal to the number of storage units. If the predetermined number of closed-state marks is not recognized (or detected or identified), the electronic device 200 may instruct, through the display, that the cover parts be closed.

The electronic device 200 may recognize an identifier rk1 when the entire memory game apparatus 100 is recognized and the predetermined number of closed-state marks is recognized. For example, when the memory game starts, a user 5 may open the first storage unit and the second storage unit, and the electronic device 200 may recognize the identifier rk1 of the first storage unit and the second storage unit.

The electronic device 200 may determine whether the identifiers rk1 of the first storage unit and the second storage unit correspond to each other. If the identifiers rk1 of the first storage unit and the second storage unit correspond to each other (i.e., the identifiers rk1 of the first and second storage units match), the electronic device 200 may display content 210 on the display. For example, the content 210 may indicate that the attempt of the user 5 is correct. If the identifiers rk1 of the first storage unit and the second storage unit correspond to each other, the electronic device 200 may display content related to the pieces of contents 4011 and 4012 on the display. The instructor may store, in the electronic device 200, content related to the pieces of contents 4011 and 4012 before the memory game is executed. After displaying the content 210, the electronic device 200 may invalidate the identifier rk1. For example, the electronic device 200 may mark the identifier rk1 as used, and ignore it in subsequent image recognition processes. Accordingly, even if the identifier rk1 is recognized in the image, the electronic device 200 may ignore it and perform processing for another identifier.

The electronic device 200 may provide the memory game through the following process. The electronic device 200 may provide a content authoring interface (or configuration tool) for the instructor to configure and manage educational content. The instructor may input information into the electronic device 200 in advance according to a learning topic. For example, the instructor may store, in the electronic device 200, information to be provided about the contents to be stored in the storage units when the memory game is played. The information may be text, an image, a video, a voice, or music. As one example, the instructor may perform a recording about the contents in advance.

When the memory game program is executed, the electronic device 200 may obtain the number of memory game players from the user (or the instructor). The user may input a name into the electronic device 200, and if the name is not input, the electronic device 200 may assign a predetermined nickname (for example, player 1, 2, and so on) to the user.

The electronic device 200 may display a notification requesting the user to select and open two storage units. The electronic device 200 may repeatedly display the request for a predetermined time until two storage units are recognized. For example, the electronic device 200 may repeatedly prompt the user for a predetermined period until two storage units are recognized. The storage units may be recognized through identifiers on the bottom surfaces of the cover parts. For example, if the predetermined time is 5 seconds and the notification is repeated 10 times, the electronic device 200 may stop the request.

When the electronic device 200 recognizes that two storage units are newly opened, it may determine whether the result is correct or incorrect and may display the result. In some embodiments, when the opening result of the two storage units is correct, the electronic device 200 may play pre-entered information of the instructor in AR and audio message formats. In some embodiments, when the opening result of the two storage units is correct, the electronic device 200 may call and execute a smart lens function to provide information about the recognized physical object. The smart lens may indicate a function that captures the object using a camera and retrieves related information by performing AI-based recognition or internet-based search. In some embodiments, when the opening result of the two storage units is incorrect, the electronic device 200 may display a request to return the storage units to their original state. The electronic device 200 may repeatedly display the request for a predetermined time. For example, if the predetermined time is 5 seconds and the notification is repeated 10 times, the electronic device 200 may stop the request.

The electronic device 200 may determine whether all storage units have been opened. If all storage units have been opened, the electronic device 200 may determine a score and terminate the game.

The electronic device 200 may output different messages according to the user's correct or incorrect result. For example, if the previous attempt was one correct answer, the electronic device 200 may output a message such as “Let's do well again this time.” If the user has answered correctly two or more times, the electronic device 200 may output messages such as “Great job! Let's keep going,” or “You've got this! Try to remember what you picked.”

If the previous attempt was one incorrect answer, the electronic device 200 may output a message such as “You can do it this time. Try to recall carefully.” If the previous attempts were consecutive incorrect answers, the electronic device 200 may output a message such as “Think about the box your friend flipped over.” If the user has made five or more consecutive incorrect attempts, and a previously opened storage unit forms a pair with a currently opened unit, the electronic device 200 may display a hint, such as visually highlighting one of the paired units in AR. The electronic device 200 may output a message such as “Want a hint?” That is, if the user has answered incorrectly more than a predetermined number of times, and a storage unit previously opened by the user forms a pair with a currently opened storage unit, the electronic device 200 may provide a hint for the corresponding storage unit.

When the memory game ends, the electronic device 200 may calculate the scores of the players, determine their rankings, and display the results.

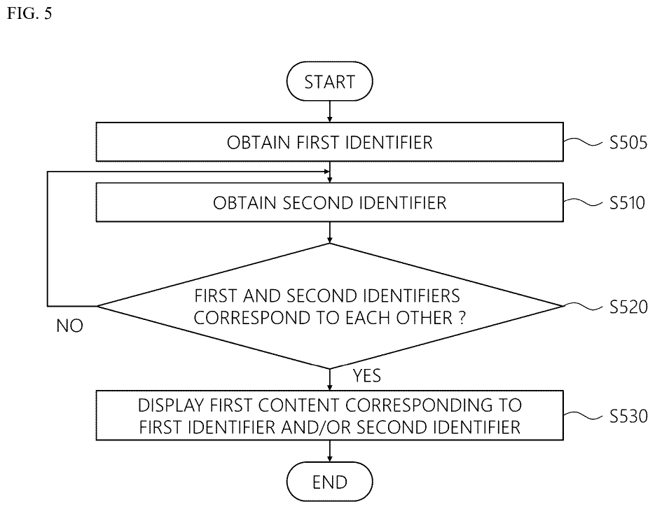

FIG. 5 is a flowchart of a method for improving memory according to an embodiment. Referring to FIG. 5, the method for improving memory according to an embodiment may be performed by an electronic device. The electronic device may recognize a memory game apparatus (for example, a memory game apparatus 100 shown in FIG. 1) in which a plurality of storage units are arranged by using a camera.

The electronic device may obtain a first identifier from the memory game apparatus (S505). The electronic device may obtain the first identifier by capturing a bottom surface of an opened cover part. The first identifier may be represented (or marked) by various types of visual codes, including but not limited to barcodes, Aztec codes, QR codes, microcodes, or the like.

In some embodiments, the electronic device may first determine whether the entire memory game apparatus is recognized (or detected or identified). If only a part (not all) of the memory game apparatus is recognized, the electronic device may display an instruction to move the camera through the display. In some embodiments, the electronic device may determine whether the entire memory game apparatus is recognized based on markings at corners of the memory game apparatus, or may determine whether the entire memory game apparatus is recognized by using an artificial neural network. In this case, the artificial neural network may be pre-trained to determine whether the entire memory game apparatus is recognized from an image acquired through the camera. The electronic device may obtain the first identifier when the entire memory game apparatus is recognized.

The electronic device may obtain a second identifier (S510). The electronic device may obtain the second identifier by capturing a bottom surface of an opened cover part. The second identifier may be represented by various types of visual codes such as the first identifier. The first identifier and the second identifier are not limited to the above examples and may be represented in various ways.

The electronic device may determine whether the first identifier and the second identifier correspond to each other (S520) (or determine whether the first identifier corresponds to the second identifier). That is, the electronic device may determine whether the opened storage units belong to the same pair. Storage units of the same pair may have the same identifier, and storage units of different pairs may have different identifiers.

If the first identifier and the second identifier correspond to each other (S520, YES), the electronic device may display a first content corresponding to the first identifier and/or the second identifier (S530). In some embodiments, the first content relates to the contents (or items) placed in the storage units having the first identifier and the second identifier and may be stored in the electronic device by the instructor before the memory game begins. For example, the contents placed in the storage units of the first identifier and the second identifier may be dandelions, and the first content may be an explanation, image, or video about the dandelions.

If the first identifier and the second identifier do not correspond to each other (S520, NO), the electronic device may correct the second identifier. For example, when the first identifier and the second identifier do not correspond to each other, the electronic device may display a message instructing the user to select another storage unit, and the user may close the storage unit of the second identifier and open a new storage unit. That is, the electronic device may prompt the user to select a different storage unit to obtain a new second identifier. The electronic device may determine whether an identifier of the new storage unit corresponds to the first identifier.

In FIG. 5, the case where the electronic device corrects the second identifier when the first identifier and the second identifier do not correspond to each other is described, but the embodiment is not necessarily limited thereto, and the electronic device may be implemented to correct the first identifier.

In some embodiments, the electronic device may determine whether the user has closed the storage unit of the first identifier or the second identifier. For example, if a new identifier is detected while the previous identifiers are still being recognized, the electronic device may determine that the storage units have not been closed properly. If the storage units are not closed, the electronic device may display a message instructing the user to close the storage units.

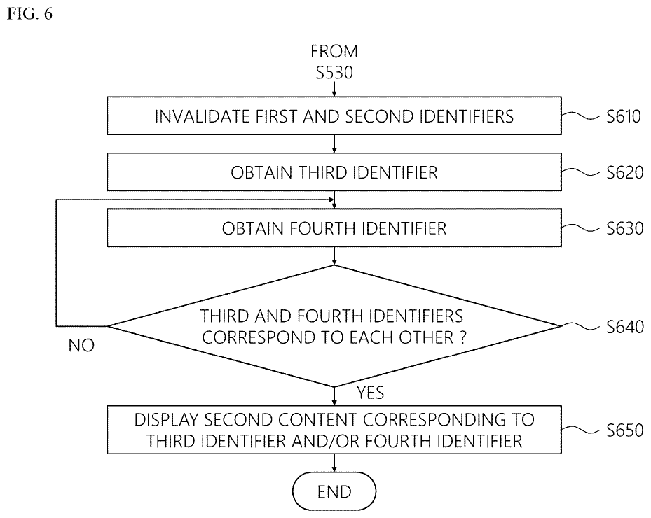

FIG. 6 is a flowchart of a method for improving memory according to an embodiment. Referring to FIG. 6, the method for improving memory according to an embodiment may be performed by an electronic device. The electronic device may display a first content corresponding to the first identifier and the second identifier and may invalidate the first identifier and the second identifier, meaning they will be excluded from further recognition, as in step S530 of FIG. 5 (S610). Accordingly, even if the first identifier and the second identifier are recognized in the image obtained through the camera, the electronic device may ignore them.

In some embodiments, the electronic device may determine a number of invalidated identifiers while invalidating the identifiers. The electronic device may determine the number of invalidated identifiers up to the present time since the memory game started. The electronic device may determine that the memory game is completed when the number of invalidated identifiers reaches a predetermined number. The predetermined number may be equal to the number of storage units of the memory game apparatus. When the memory game is completed, the electronic device may determine a score.

The electronic device may obtain a third identifier (S620). In some embodiments, when the number of invalidated identifiers has not reached the predetermined number, that is, when it is determined that the game is not completed, the electronic device may obtain the third identifier.

The electronic device may obtain a fourth identifier (S630).

The electronic device may determine whether the third identifier and the fourth identifier correspond to each other (S640) (or determine whether the third identifier corresponds to the fourth identifier).

The configuration in which the electronic device obtains the third identifier and the fourth identifier and determines whether they correspond to each other may be the same as the configuration described in FIG. 5 in which the electronic device obtains the first identifier and the second identifier and determines whether they correspond to each other. Therefore, redundant descriptions are omitted.

If the third identifier and the fourth identifier correspond to each other (S640, YES), the electronic device may display a second content corresponding to the third identifier and/or the fourth identifier (S650). For example, the electronic device may display educational content, such as an explanation, image, or video, associated with the matched identifiers. In some embodiments, the second content relates to the contents placed in the storage units of the third identifier and the fourth identifier, and may be stored in the electronic device by the instructor before the memory game begins. For example, the contents placed in the storage units of the third identifier and the fourth identifier may be chestnut burrs, and the second content may be an explanation, image, video, or the like about the chestnut burrs. As such, the instructor may pre-store in the electronic device the content corresponding to all identifiers of the memory game apparatus.

If the third identifier and the fourth identifier do not correspond to each other (S640, NO), the electronic device may correct the fourth identifier. For example, when the third identifier and the fourth identifier do not correspond to each other, the electronic device may display a message instructing the user to select another storage unit, and the user may close the storage unit of the fourth identifier and open a new storage unit. The electronic device may determine whether the identifier of the new storage unit corresponds to the third identifier.

Although FIG. 5 describes a case in which the electronic device corrects the fourth identifier when the third identifier and the fourth identifier do not correspond to each other, the embodiment is not necessarily limited thereto, and the electronic device may be implemented to correct the third identifier.

In some embodiments, the electronic device may determine whether the user has closed the storage unit of the third identifier or the fourth identifier. For example, when a new identifier is recognized while the third identifier and the fourth identifier are being recognized, the electronic device may determine that the storage unit has not been closed. If the storage unit is not closed, the electronic device may display a message instructing the user to close the storage unit.

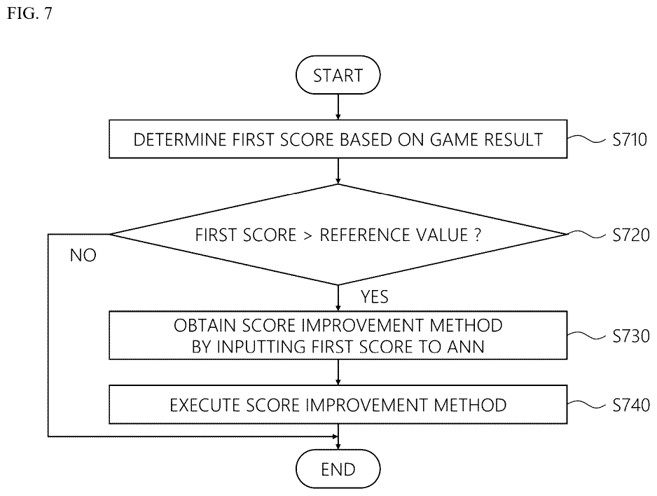

FIG. 7 is a flowchart of a method for improving memory according to an embodiment. Referring to FIG. 7, the method for improving memory according to an embodiment may be performed by an electronic device. When a memory game is completed, the electronic device may determine a first score based on a game result (S710). In some embodiments, the electronic device may determine the first score based on at least one of a first play time, a first error rate, and a first number of attempts. For example, the electronic device may determine a value obtained by summing the first play time, the first error rate, and the first number of attempts as the first score. In another embodiment, the electronic device may determine a value obtained by summing a number of plays, the first play time, the first error rate, and the first number of attempts as the first score. In some embodiments, a lower score may indicate a relatively better performance, and a higher score may indicate a relatively inferior performance. That is, the lower score may indicate better memory performance, whereas the higher score may indicate the need for improvement.

In some embodiments, when the memory game is completed, the electronic device may calculate a score for quantitatively evaluating the user's memory and concentration levels. The electronic device may determine a number of pairs based on the total number of storage units, and record numbers of correct and incorrect attempts made by the user and the total elapsed time until the game ends. The electronic device may calculate an average error rate per correct answer and an average time consumed per pair.

The electronic device may determine the average error rate per correct answer as the number of incorrect attempts divided by the number of correct attempts. The electronic device may determine the average time per pair as the total elapsed time divided by the number of pairs. The electronic device may calculate a score based on both the average error rate per correct answer and the average time per pair. For example, the electronic device may calculate the score according to Equation 1 below.

$$Score = α * ( W / C ) + β * ( S / N ) \qquad [ Equation 1 ]$$

Here, α may be a first weight related to the error rate (i.e., accuracy), and β may be a second weight related to the time taken (i.e., speed). N denotes the total number of pairs, W denotes the number of incorrect attempts (i.e., a number of incorrect pair matching attempts), C denotes the number of correct attempts (i.e., a number of correctly matched pairs), and S denotes the total elapsed time (in seconds) from start to end of the game.

The first weight and the second weight may be adjusted based on system settings or the age of the user. For example, for younger users, accuracy may be prioritized over speed, and thus the first weight α may be set greater than the second weight β. For adult users, speed may be prioritized, and the second weight β may be set greater than the first weight α. A lower score indicates better performance, while a higher score may indicate a larger number of incorrect attempts or slower game progress.

For example, in a memory game with 20 storage units, the total number of pairs N is 10. If the user correctly matches all 10 pairs, with 5 incorrect attempts, and the total elapsed time S is 150 seconds, the electronic device may calculate the score as follows. Assuming α=0.6 and β=0.4, W/C= 5/10=0.5, and S/N=150/10=15, the score may be calculated as: Score=0.6×0.5+0.4× 15=0.3+6.0=6.3. The calculated score may then be compared with a reference value to determine whether the user requires memory enhancement, or whether a score improvement method should be provided by the artificial neural network.

Additionally, the electronic device may calculate a second score for a restarted memory game using the same calculation method, and may quantitatively evaluate memory improvement based on the difference between the first and second scores. The score difference may also be used for training the artificial neural network or for determining the reward. Unlike conventional memory games that evaluate performance based solely on correct or incorrect answers, this approach enables comprehensive evaluation of memory improvement by considering both accuracy and speed.

The electronic device may determine whether the first score is greater than a reference value (S720). That is, the electronic device may determine whether improvement of the user's memory ability is required based on the first score of the memory game performed by the user.

If the first score is less than or equal to the reference value (S720, NO), the electronic device may retain the first score. The electronic device may determine that the user's memory ability is excellent and may terminate the memory game.

If the first score is greater than the reference value (S720, YES), the electronic device may obtain a score improvement method by inputting the first score to an artificial neural network (S730). For example, the electronic device may obtain a personalized memory training strategy (or method) by inputting the first score into the artificial neural network. In some embodiments, the artificial neural network may be implemented inside the electronic device or may be implemented in a device external to the electronic device (for example, a server, and the like). The artificial neural network may be pre-trained to estimate the user's memory level based on the first score and to provide an optimal score improvement method corresponding to the memory.

For example, the artificial neural network may provide a score improvement method such as pattern recognition training, visual image association, repetitive practice, meditation and deep breathing, or pre-learning. The pattern recognition training may be, for example, training in which the user concentrates on memorizing the contents of four storage units, and then memorizes the contents of the next four storage units. The user may sequentially memorize subsets of four storage units to improve focus and recall.

The visual image association may be a method of associating images when memorizing a pair of identical storage units by linking the images of the two storage units. The user may form an associative link between the visual representations of paired storage units. For example, when each of the two storage units contains a seed, the user may imagine an image in which the two seeds are attached together.

In addition, the user may be guided to stabilize the mind and increase concentration through brief meditation or deep breathing before the memory game. Meditation music may be used to induce meditation and deep breathing at a predetermined time and at a predetermined pace of breathing.

The pre-learning may be learning about the contents of the memory game. It may be a score improvement method that utilizes the principle that memory tends to last longer for familiar objects. The principle may indicate familiarity with objects and enhance memory retention.

The electronic device may execute the score improvement method received from the artificial neural network (S740). For example, the electronic device may provide the user with at least one of pattern recognition training, visual image association, repetitive practice, meditation and deep breathing, and pre-learning. The user may perform the score improvement method by using the electronic device.

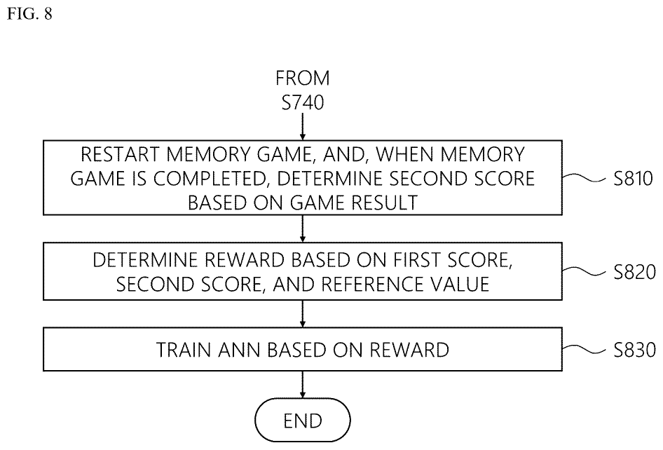

FIG. 8 is a flowchart of a method for improving memory according to an embodiment. Referring to FIG. 8, the method for improving memory according to an embodiment may be performed by an electronic device. The electronic device may execute a score improvement method, as in step S740 of FIG. 7, restart the memory game, and, when the memory game is completed, determine a second score based on a game result (S810). That is, the electronic device may restart the memory game and determine the second score upon its completion. For example, the electronic device may determine the second score based on at least one of: a second play time, a second error rate, and a second number of attempts of the restarted memory game. The electronic device may determine the second score in the same manner as determining the first score.

The electronic device may determine a reward based on the first score, the second score, and a reference value (S820). For example, when the second score is higher than the first score, the electronic device may determine a first reward as the reward for the artificial neural network. When the second score is lower than the first score but higher than the reference value, the electronic device may determine a second reward as the reward. When the second score is lower than the reference value, the electronic device may determine a third reward as the reward. In this case, the first reward may be less than 0, the second reward may be equal to or greater than 0, and the third reward may be greater than the second reward.

In some embodiments, the electronic device may analyze the results of a retried memory game and determine a reward value to be provided to the artificial neural network based on the analysis, in order to quantitatively evaluate whether the user's memory has improved. More specifically, the electronic device may calculate a reward value by comparing a first score (S1) generated upon the initial completion of the memory game, a second score (S2) generated upon completion of the retried memory game after the user performed a score improvement method received from the artificial neural network, and a baseline value (B).

S1 may represent the user's memory or concentration level before receiving feedback from the artificial neural network, while S2 may represent the performance after reattempting the game based on the feedback. The baseline value B may represent a target performance level defined by the system, and may be determined, for example, based on an average user performance, the user's prior average performance, or difficulty levels adjusted by age.

The electronic device may determine the reward differently based on the relative relationship among S1, S2, and B. First, when S2 is greater than S1, i.e., when the performance decreases after receiving feedback from the artificial neural network, a negative reward value should be provided. In such a case, the electronic device may determine a first reward R1 by multiplying the score difference ΔS=|S1−S2| by a negative weight λ. R1 may be expressed as a negative real number, thereby allowing performance degradation to be reflected in training.

On the other hand, when S2 is less than or equal to S1, i.e., when the user's performance is maintained or improved, and in particular, when S2 is greater than the baseline B, the user has not yet met an expected standard. In this case, the electronic device may determine a second reward R2 by multiplying the score difference ΔS by a positive weight μ. R2 may be a non-negative real number, indicating partial improvement that has not yet reached the desired level.

Finally, when S2 is less than or equal to B, i.e., when the user's performance meets or exceeds the baseline, it may be interpreted that the feedback from the artificial neural network was effective. Accordingly, the electronic device may determine a third reward R3 by multiplying (B−S2) by a positive weight v. R3 may be set greater than R2, thereby enabling tiered reward levels based on whether the baseline has been achieved.

For example, if S1=7.0, S2=5.5, and B=6.0, then ΔS=1.5, and since S2 is less than B, R3 may be calculated as: R3=v×(B−S2)=1.5×0.5=0.75. Conversely, if S2 were 6.5 (i.e., greater than the baseline), then R2 would be calculated as: R2=μ×ΔS=1.0×0.5=0.5. In some embodiments, v may be greater than μ, although this is not necessarily required. The reward values calculated as above may be used as feedback signals to update the policy parameters during reinforcement learning of the artificial neural network.

By repeatedly applying this reward determination logic, the electronic device may collect data regarding the effectiveness of score improvement methods for each individual user as training data. This reward-based feedback serves as a foundation for the artificial neural network to selectively recommend more effective improvement methods to users under similar training conditions in the future. Specifically, the electronic device may record the first score, second score, baseline value, and score difference (ΔS) in real time and use these data in combination to generate reward values, thereby producing feedback tailored to the individual learning history of the user.

Furthermore, after determining the reward, the electronic device may input the reward into the artificial neural network as input for reinforcement learning. Reinforcement learning may be implemented using algorithms such as Q-Learning, Deep Q Network (DQN), or Proximal Policy Optimization (PPO). The reward may be used as a reward signal for determining the direction and magnitude of updates to the policy function. Specifically, the electronic device may store the user's game data along with the reward value in the format of (State(t), Action(t), Reward(t), State(t+1)), and use this data to update the weights of the policy network via backpropagation. Such a configuration enables the generation of user-specific memory improvement methods that evolve continuously, rather than being limited to one-time recommendations.

The electronic device may train the artificial neural network based on the reward (S830). The electronic device may assign the reward to the artificial neural network. As an example of training the artificial neural network, reinforcement learning may be used. The artificial neural network may be trained using reinforcement learning, in which the reward serves as feedback to update the network parameters. That is, the reward may be provided as an evaluation of the score improvement method output by the artificial neural network. The artificial neural network may adjust parameters based on the reward.

In some embodiments, the electronic device may additionally take into account a cumulative number of plays to determine the reward and train the artificial neural network accordingly. That is, the electronic device may determine the reward based on the cumulative number of plays, the first score, the second score, and the reference value, and may perform reinforcement learning on the artificial neural network based on the reward. That is, by additionally considering the user's cumulative number of plays, the artificial neural network may perform learning to more precisely recommend an efficient score improvement method.

In some embodiments, the electronic device may train the artificial neural network based on the reward value calculated in step S820. The electronic device may quantitatively evaluate the effectiveness of the score improvement method recommended by the artificial neural network to the user, and may optimize the policy model by adjusting internal parameters of the artificial neural network based on the evaluation results. To this end, the electronic device may adopt a reinforcement learning structure and may generate training samples that include state, action, reward, and next state, which are core components of reinforcement learning. The electronic device may then perform iterative training based on the training samples.

More specifically, the electronic device may generate state information (State(t)) including, for example, the first score (S1), the second score (S2), a baseline value (B), user identification information, and a cumulative number of plays. The electronic device may designate, as an action (Action(t)), one of the score improvement methods selected among those recommended by the artificial neural network. After the user performs the selected action, the electronic device may calculate a reward value (Reward(t)) based on the second score (S2) resulting from the game outcome, and may designate the user's updated status as next state (State(t+1)).

The electronic device may configure (State(t), Action(t), Reward(t), State(t+1)) as a single training sample and may store it in an experience memory for training the artificial neural network. Periodically, or when the number of accumulated training samples exceeds a predefined threshold, the electronic device may randomly select multiple training samples from the experience memory to form a mini-batch and may update the weights of the artificial neural network by calculating a loss function.

For example, the electronic device may use the following Equation 2 as the loss function.

$$Loss = {( R ( t ) + γ \times max ( Q ( State ( t + 1 ) , {a}^{′} ) ) - Q ( State ( t ) , Action ( t ) ) )}^{2} \qquad [ Equation 2 ]$$

Here, Q denotes an action-value function predicted by the policy network, γ is a reward discount factor, a′ represents an action with the maximum value among all possible actions in the next state (State(t+1)), and Q(State(t), Action(t)) represents the value predicted by the current policy network. The electronic device may perform a backpropagation algorithm based on the loss function to update parameters of the artificial neural network, thereby forming a policy model that can select a more appropriate score improvement method under similar circumstances in the future.

In some embodiments, the electronic device may be configured to adjust learning parameters such as learning rate, batch size, and discount factor according to system settings or user age group, thereby enabling training pathways tailored to user types. For example, for younger users, the policy function may be tuned to favor repetitive training or visual association methods, while for older users, the reinforcement learning may be guided to reward techniques that promote cognitive stabilization, such as meditation or deep breathing.

By repeatedly performing such a reinforcement learning-based training structure, the electronic device may continuously enhance the accuracy and personalization level of score improvement methods recommended by the artificial neural network. This training strategy, which repeatedly reflects user-specific performance and feedback, allows for ongoing optimization based on accumulated training data, rather than one-time feedback. Accordingly, the memory improvement system based on the artificial neural network according to the present invention may substantially improve the efficiency of learning and user satisfaction.

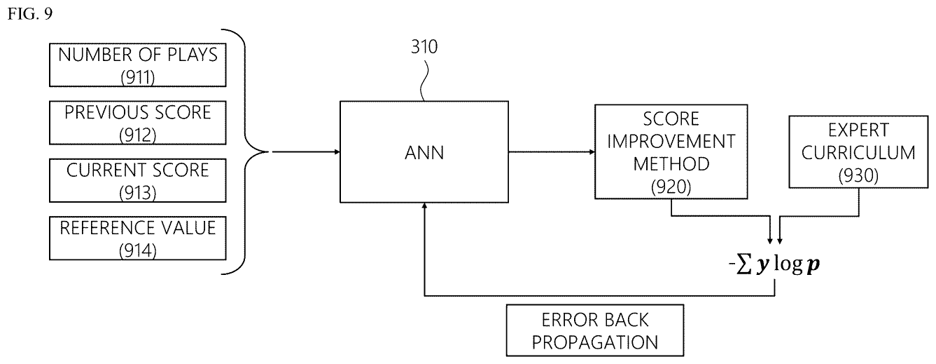

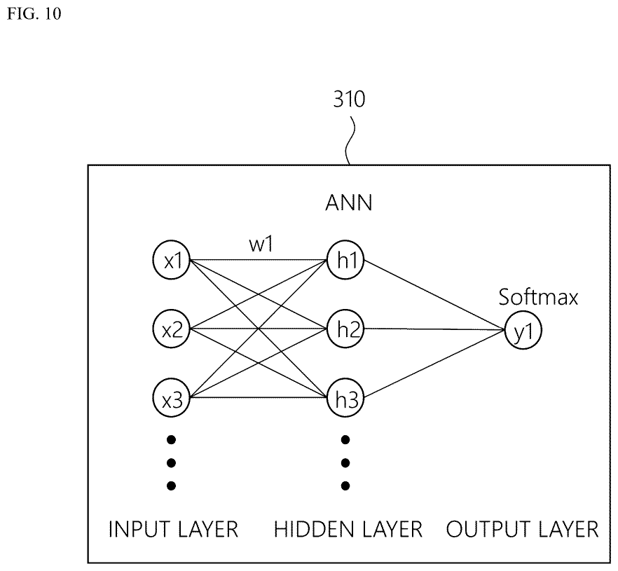

FIG. 9 is a diagram for illustrating a training session of an artificial neural network according to an embodiment, and FIG. 10 is a diagram for illustrating a structure of an artificial neural network according to an embodiment. Referring to FIG. 9, the artificial neural network 310 according to an embodiment may receive a number of plays 911, a previous score 912, a current score 913, and a reference value 914 during an inference session. The artificial neural network 310 may be configured to generate a score improvement method 920 based on the number of plays 911, the previous score 912, the current score 913, and the reference value 914. Although FIG. 9 illustrates that the artificial neural network 310 receives the previous score 912 and the current score 913, the embodiment is not necessarily limited thereto, and the artificial neural network 310 may be implemented to receive all scores accumulated thus far from previous plays.

In order for the artificial neural network 310 to generate the score improvement method 920, it must have nodes and weights corresponding to the nodes through a training session that precedes the inference session. Hereinafter, a training session of the artificial neural network 310 will be described.

Referring to FIGS. 9 and 10, the artificial neural network 310 may be implemented as a multilayer neural network model, such as deep learning or a deep neural network model. The multilayer neural network model may include an input layer, a hidden layer, and an output layer. At each node of the multilayer neural network model, actual computation takes place, and this computation process is mathematically designed to simulate the behavior of neurons that constitute a human neural network. A node responds when it receives a stimulus above a certain threshold, and the magnitude of the response is roughly proportional to the value obtained by multiplying input values (such as x1, x2, x3, etc.) and the weights (such as w1, etc.) of the node, excluding the bias value.

The input layer is composed of nodes corresponding to respective input variables, and the number of nodes is equal to the number of input variables. The number of plays 911, the previous score 912, the current score 913, and the reference value 914 may be provided to respective nodes of the input layer as input data.

The number of plays 911, the previous score 912, the current score 913, and the reference value 914 may be vectorized before being input to the input layer. That is, the reference value 914 may be converted into a vector form. The number of plays 911, the previous score 912, the current score 913, and the reference value 914 may be computed based on weights and transmitted to the hidden layer. The reference value 914 may be processed through weighted computation and forwarded to the hidden layer. In some embodiments, the electronic device may further input at least one of play time, error rate, and number of attempts to the artificial neural network 310, along with the previous score 912 and the current score 913.

The hidden layer performs nonlinear processing of a linear combination of variable values transmitted from the input layer using a nonlinear function such as a sigmoid function, and transmits the result to the output layer or to another hidden layer. (Recently, in backpropagation, a vanishing gradient problem occurs in which the error is attenuated in earlier layers when applying the chain rule, so ReLU is generally used instead of the sigmoid function.) The output layer includes nodes corresponding to output variables, and in a classification model, the number of output nodes corresponds to the number of classes.

The computation result of the hidden layer is transmitted to the output layer, and the output layer may output a score improvement method 920 based on an activation function. For example, the activation function may include softmax, ReLU, sigmoid, hyperbolic tangent (tan H), or the like.

An error between the outputted score improvement method 920 and an expert curriculum 930 (or ground truth) is calculated, and backpropagation may be performed to update the weights of the hidden layer in a direction that reduces this error. The error may be expressed as −Sigma(y log p), where p and y represent the score improvement method 920 and the expert curriculum 930 (or ground truth), respectively.

In other words, the output obtained by multiplying input variables and weights becomes the input to the next layer, and all the resulting products are summed (net input function), and the sum is input to the activation function. The weighted sums are calculated, and this result serves as the input to the activation function. The result of the activation function corresponds to the output of the node, and this output value is ultimately used for classification or regression analysis. All weights are gradually updated during the training process, and this reflects which inputs are considered important by each node. The “training session” of the neural network model may be a process of updating these weights.

The artificial neural network 310 trained as described above may have weights as internal parameters, and when the number of plays 911, the previous score 912, the current score 913, and the reference value 914 are input in an inference session, the artificial neural network 310 may output a score improvement method 920 based on the weights. By outputting a user-customized score improvement method 920, the artificial neural network 310 may enable the user to improve memory ability and concentration quickly and efficiently. That is, the artificial neural network 310 may recommend methods tailored to individual user characteristics, such as a user who has played many times but shows no progress, or a user who improves their score with minimal coaching. The electronic device may execute the score improvement method 920, and the user may perform the score improvement method 920 through the electronic device.

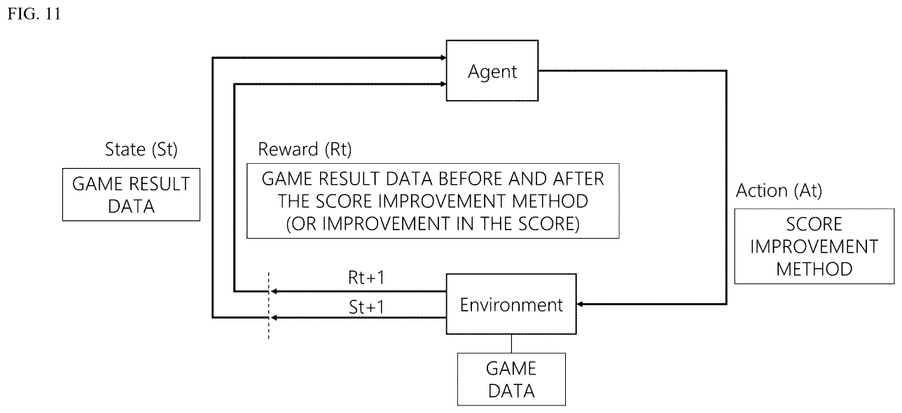

FIG. 11 is a diagram for illustrating a training session of an artificial neural network according to an embodiment. Referring to FIG. 11, the artificial neural network according to an embodiment may use reinforcement learning to determine a score improvement method.

In the reinforcement learning of the artificial neural network for the score improvement method, the game data may serve as (or corresponds to) an Environment, the artificial neural network module may be an Agent, the score improvement method output by the artificial neural network module may be an Action (At), the game result data may serve as a State (St), and the difference between the game result data before and after the score improvement method (or improvement in the score) may be a Reward (Rt), with which the artificial neural network module may be updated. The game data may include the number of plays, score records, reference value, error rate, play time, and number of attempts. The game result data may include a score.

The electronic device may train the user based on the determined score improvement method (At), and may obtain game data of the restarted memory game after the training. The electronic device may calculate a degree of improvement based on the first score of the previous memory game and the second score of the restarted memory game, and may input the degree of improvement as a Reward (Rt+1) to the Agent. In addition, the electronic device may input the second score of the restarted memory game as a State (St+1) to the Agent.

The artificial neural network module may perform reinforcement learning to provide a score improvement method for improving the memory game score according to the current level of the user. The artificial neural network module may provide different score improvement methods in each of the following cases: when the second score is higher than the first score, when the second score is higher than the reference value but lower than the first score, and when the second score is lower than the reference value. That is, the artificial neural network module may perform learning in a direction to efficiently improve the score according to the user's level. The artificial neural network module may be trained to adaptively improve scores according to the user's performance level.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

In some embodiments, each component or a combination of two or more components described with reference to FIG. 1 to FIG. 11 may be implemented with digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in the present disclosure can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, LED (light-emitting diode) monitor, OLED (organic LED) monitor, LCoS (liquid crystal on silicon) display, LEDoS (LED on silicon) display, OLEDoS (OLED on silicon) display, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method for improving memory, the method comprising:
obtaining a first identifier;
obtaining a second identifier;
determining whether the second identifier corresponds to the first identifier;
displaying first content corresponding to the first identifier or the second identifier in response to determining that the second identifier corresponds to the first identifier; and
correcting the second identifier in response to determining that the second identifier does not correspond to the first identifier.

2. The method of claim 1, further comprising:
invalidating the first identifier and the second identifier in response to determining that the second identifier corresponds to the first identifier;
obtaining a third identifier;
obtaining a fourth identifier;
determining whether the fourth identifier corresponds to the third identifier;
displaying second content corresponding to the third identifier or the fourth identifier in response to determining that the fourth identifier corresponds to the third identifier; and
correcting the fourth identifier in response to determining that the fourth identifier does not correspond to the third identifier.

3. The method of claim 1, further comprising:
invalidating the first identifier and the second identifier in response to determining that the second identifier corresponds to the first identifier;
determining a number of invalidated identifiers;
determining a first score in response to determining that the number of invalidated identifiers reaches a predetermined number; and
obtaining a third identifier in response to determining that the number of invalidated identifiers does not reach the predetermined number.

4. The method of claim 3, wherein the determining the first score comprises:
determining the first score based on at least one of a first play time, a first error rate, and a first number of attempts;
obtaining a score improvement method by inputting the first score to an artificial neural network in response to determining that the first score is greater than a reference value; and
maintaining the first score in response to determining that the first score is less than or equal to the reference value.

5. The method of claim 4, wherein the determining the first score comprises:
determining the first score as a sum of the first play time, the first error rate, and the first number of attempts.

6. The method of claim 4, further comprising:
restarting a memory game after executing the score improvement method in response to determining that the first score is greater than the reference value;
determining a second score based on at least one of a second play time, a second error rate, and a second number of attempts of the restarted memory game; and
training the artificial neural network based on the first score, the second score, and the reference value.

7. The method of claim 6, wherein the training the artificial neural network comprises:
determining a first reward as a reward for the artificial neural network in response to determining that the second score is higher than the first score;
determining a second reward as the reward in response to determining that the second score is lower than the first score but higher than the reference value; and
determining a third reward as the reward in response to determining that the second score is lower than the reference value, wherein the first reward is less than zero, the second reward is greater than or equal to zero, and the third reward is greater than the second reward.

8. The method of claim 6, wherein the training the artificial neural network comprises: training the artificial neural network based on a cumulative number of plays, the first score, the second score, and the reference value.

9. The method of claim 1, further comprising:
detecting, using a camera, a memory game apparatus on which the first identifier and the second identifier are arranged;
determining whether the entire memory game apparatus is recognized;
obtaining the first identifier in response to determining that the entire memory game apparatus is recognized; and
displaying an instruction to detect the entire memory game apparatus in response to determining that the entire memory game apparatus is not recognized.

10. An electronic device for improving memory, comprising:
at least one processor; and
a memory connected to the at least one processor,
wherein the memory is configured to store a program, wherein the at least one processor is configured to execute the program, and wherein, if executed, the program causes the at least one processor to perform the steps of the method according to claim 1.
